(19) United States
(12) Patent Application Publication
(10) Pub. No.: US 2024/0013755 A1
(43) Pub. Date: Jan. 11, 2024

(54) EDITING OF AUDIO FILES

(71) Applicant: Soundtrap AB, Stockholm (SE)

(72) Inventors: Pierre ROY, Paris (FR); Francois PACHET, Paris (FR)

(73) Assignee: Soundtrap AB, Stockholm (SE)

(21) Appl. No.: 18/336,841

(22) Filed: Jun. 16, 2023

(30) Foreign Application Priority Data
Jul. 8, 2022 (EP) 22183910.3

(51) Int. Cl. G10H 1/00

(52) U.S. Cl. CPC G10H 1/0008; G10H 1/0066; G10H 2240/021; G10H 2220/126

(57) ABSTRACT

This disclosure relates to editing an audio file of a time stream having a plurality of tones T. The stream is cut at a first time point of the stream, producing a first cut A cutting the stream into a first stream and a second stream, whereby each tone which extends across the first cut, is cut into a first part Ta which is in the first stream and a second part Tb which is in the second stream. For each of the tones extending across the first cut, a respective memory space is allocated to each of the first part and the second part, each of the memory spaces storing an original state of the tone. The first stream is allocated with a further stream, comprising adjusting the first part of one of the tones based on the information stored in the memory space allocated to said first part.

### RELATED APPLICATIONS

This application claims priority to European Application No. EP22183910.3 filed Jul. 8, 2022, which is hereby incorporated by reference in its entirety.

### TECHNICAL FIELD

The present disclosure relates to a method and an editor for editing an audio file.

### BACKGROUND

Music performance can be represented in various ways, depending on the context of use: printed notation, such as scores or lead sheets, audio signals, or performance acquisition data, such as piano-rolls or Musical Instrument Digital Interface (MIDI) files. Each of these representations captures partial information about the music that is useful in certain contexts, with its own limitations. Printed notation offers information about the musical meaning of a piece, with explicit note names and chord labels (in, e.g., lead sheets), and precise metrical and structural information, but it tells little about the sound. Audio recordings render timbre and expression accurately, but provide no information about the score. Symbolic representations of musical performance, such as MIDI, provide precise timings and are therefore well adapted to edit operations, either by humans or by software.

A need for editing musical performance data may arise from two situations. First, musicians often need to edit performance data when producing a new piece of music. For instance, a jazz pianist may play an improvised version of a song, but this improvisation should be edited to accommodate for a posteriori changes in the structure of the song. The second need comes from the rise of Artificial Intelligence (AI)-based automatic music generation tools. These tools may usually work by analysing existing human performance data to produce new ones. Whatever the algorithm used for learning and generating music, these tools call for editing means that preserve as far as possible the expressiveness of original sources.

However, editing music performance data raises special issues related to the ambiguous nature of musical objects. A first source of ambiguity may be that musicians produce many temporal deviations from the metrical frame. These deviations may be intentional or subconscious, but they may play an important part in conveying the groove or feeling of a performance. Relations between musical elements are also usually implicit, creating even more ambiguity. A note is in relation with the surrounding notes in many possible ways, e.g. it can be part of a melodic pattern, and it can also play a harmonic role with other simultaneous notes, or be a pedal-tone. All these aspects, although not explicitly represented, may play an essential role that should preferably be preserved, as much as possible, when editing such musical sequences.

The MIDI file format has been successful in the instrument industry and in music research and MIDI editors are known, for instance in Digital Audio Workstations. However, there may be problems with editing MIDI with semantic-preserving operations. Attempts to provide semantically preserving edit operations have been made on the audio domain (e.g. by Whittaker, S., and Amento, B. “Semantic speech editing”, in Proceedings of the SIGCHI conference on Human factors in computing systems (2004), ACM, pp. 527-534) but these attempts are not transferrable to music performance data, as explained below.

In human-computer interactions, cut, copy and paste are the so called the holy trinity of data manipulation. These three commands have proved so useful that they are now incorporated in almost every software, such as word processing, programming environments, graphics creation, photography, audio signal, or movie editing tools. Recently, they have been extended to run across devices, enabling moving text or media from, for instance, a smartphone to a computer. These operations are simple and have clear, unambiguous semantics: cut, for instance, consists in selecting some data, say a word in a text, removing it from the text, and saving it to a clipboard for later use.

Each type of data to be edited raises its own editing issues that have led to the development of specific editing techniques. For instance, editing of audio signals usually requires cross fades to prevent clicks. Similarly, in movie editing, fade-in and fade-out are used to prevent harsh transitions in the image flow. Edge detection algorithms were developed to simplify object selection in image editing. The case of MIDI data is no exception. Every note in a musical work is related to the preceding, succeeding, and simultaneous notes in the piece. Moreover, every note is related to the metrical structure of the music.

US 2014/0354434 discloses a method for modifying a media. A media modification unit is adapted to retrieve, from a database, a transition and/or target playback position that corresponds to an actual playback position, and modify the playback.

EP 3 706 113 discloses a method of editing an audio stream in which a respective memory cell is allocated to each end formed by a cut made in said audio stream.

### SUMMARY

It is an objective of the present invention to facilitate editing of musical performance data represented as an editable audio file, e.g. MIDI, while preserving its semantic.

According to an aspect of the present invention, there is provided a method of editing an audio file. The audio file comprises information about a time stream having a plurality of tones extending over time in said stream. The method comprises cutting the stream at a first time point of the stream, producing a first cut cutting the stream into a first stream and a second stream, whereby each tone, of the plurality of tones, which extends across the first cut, is cut into a first part which is in the first stream and a second part which is in the second stream. The method also comprises, for each of the tones extending across the first cut, allocating a respective memory space to each of the first part of the tone and the second part of the tone, each of the memory spaces storing information about an original state of the tone, typically comprising or consisting of the original duration of the tone. The method also comprises concatenating the first stream with a further stream, comprising adjusting, typically the duration of, the first part of one of the tones which extended over the first cut based on the information stored in the memory space allocated to said first part of the tone.

According to another aspect of the present invention, there is provided a computer program product comprising computer-executable components for causing an audio editor to perform an embodiment of the method of the present disclosure when the computer-executable components are run on processing circuitry comprised in the audio editor.

According to another aspect of the present invention, there is provided an audio editor configured for editing an audio file. The audio file comprises information about a time stream having a plurality of tones extending over time in said stream. The audio editor comprises processing circuitry, and data storage storing instructions executable by said processing circuitry whereby said audio editor is operative to perform an embodiment of the method of the present disclosure.

By allocating a respective memory space to each part of a tone being cut, each of said memory spaces storing information about the original state of the tone, e.g. comprising any or all of duration, pitch and velocity of the original tone, this information can be taken into account to adjust the tone during concatenation streams, or other editing operations, e.g. for removing artefacts in the merged stream formed by the concatenation. Also, the original state of the tone can be recreated after any number of editing operations.

It is to be noted that any feature of any of the aspects may be applied to any other aspect, wherever appropriate. Likewise, any advantage of any of the aspects may apply to any of the other aspects. Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated. The use of “first”, “second” etc. for different features/components of the present disclosure are only intended to distinguish the features/components from other similar features/components and not to impart any order or hierarchy to the features/components.

### BRIEF DESCRIPTION OF THE DRAWINGS

Embodiments will be described, by way of example, with reference to the accompanying drawings, in which:

FIG. 1a illustrates a time stream of an audio file, having a plurality of tones at different pitch and extending over different time durations, a time section of said stream being cut out from one part of the stream and inserted at another part of the stream, in accordance with some embodiments of the present invention.

FIG. 1b illustrates the time stream of FIG. 1a after the time section has been inserted, showing some different types of artefacts initially caused by the cut out and insertion, which may be handled in accordance with some embodiments of the present invention.

FIG. 1c illustrates the time stream of FIG. 1b, after processing to remove artefacts, in accordance with some embodiments of the present invention.

FIG. 2 illustrates information which can be stored in respective memory spaces cell of parts of a tone extending across a cut, in accordance with some embodiments of the present invention.

FIG. 3 illustrates a) a stream being cut in the middle of a tone, b) producing two separate streams where the tone fragments are removed, and c) reconnecting (concatenating) the two streams to produce the original stream and recreating the tone, in accordance with some embodiments of the present invention.

FIG. 4a is a schematic block diagram of an audio editor, in accordance with some embodiments of the present invention.

FIG. 4b is a schematic block diagram of an audio editor, illustrating more specific examples in accordance with some embodiments of the present invention.

FIG. 5 is a schematic flow chart of a method in accordance with some embodiments of the present invention.

### DETAILED DESCRIPTION

Embodiments will now be described more fully hereinafter with reference to the accompanying drawings, in which certain embodiments are shown. However, other embodiments in many different forms are possible within the scope of the present disclosure. Rather, the following embodiments are provided by way of example so that this disclosure will be thorough and complete, and will fully convey the scope of the disclosure to those skilled in the art. Like numbers refer to like elements throughout the description.

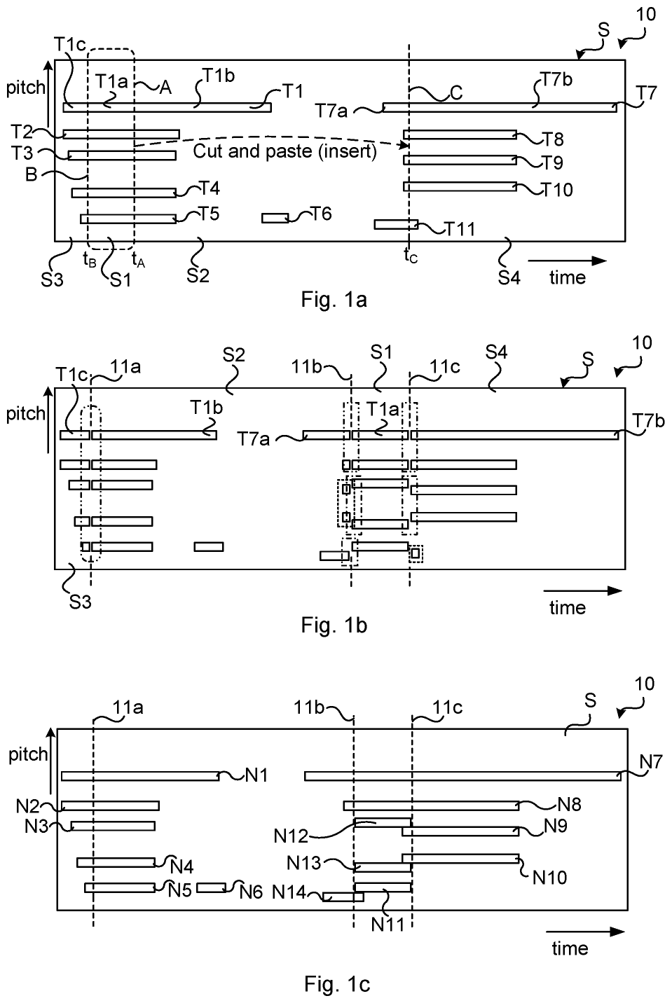

Herein, the problem of editing non-quantized, metrical musical sequences represented as e.g. MIDI files is discussed. A number of problems caused by the use of naive edition operations applied to performance data are presented using a motivating example of FIGS. 1a and 1b. A way of handling these problems is in accordance with the present invention to allocate a respective memory spaces to each part of a tone (also called note) formed by cutting an audio stream at a certain time point during editing thereof. A memory space, as presented herein, can be regarded as a part of a data storage, e.g. of an audio editor, used for storing information relating to tones affected by the cutting. The information stored may typically relate to the properties (e.g. length/duration, pitch, velocity/loudness etc.) of the original states of the tones, i.e. not necessarily to the state directly before the cutting since also prior editing operations may have affected the tones. Typically, the stored information comprises or consists of information about the duration of the original tone. By means of the memory spaces, and the information stored therein, an edited audio stream can be processed to remove the artefacts. Thus, the artefacts of FIG. 1b may be removed in accordance with the result of FIG. 1c.

The cutting of the time stream, as used herein, implies that the stream is split or allocated into two different streams, one which corresponds to the time stream before the time point at which the time stream is cut and one which corresponds to the time stream after the time point at which the time stream is cut. The cut is thus transverse to a time axis of the time stream.

The concatenating of one stream with another, may correspond to the streams being directly connected to each other. However, in other embodiments, the streams may be connected to each other via an intermediate stream.

The two time streams which are concatenated may in some cases be time streams that used to be part of the same time stream before it was split into the two time streams, i.e. the concatenation is the reversal of a previous split of a time stream. In such cases, the tones affected by the split may be recreated to their original state (especially duration) during the concatenation by means of the stored information about the original state of each tone in the respective memory spaces allocated to the parts thereof. However, in other cases, e.g. if two time streams that did not originally form part of a same time stream are concatenated, the stored information of the partial tones may still aid in extending one or some of the partial tones across the seam between the two streams being concatenated e.g. if it is determined that it would make musical sense to extend the partial tone e.g. to its original duration. In a special case, e.g. if the two streams originally formed a time stream before being split to form the two streams but tones of one of the streams have been pitch shifted before the streams are re-concatenated, a first partial tone may no longer fit together with the second partial tone which the original tone was split into (due to different pitches). However, there is still the possibility of merging the first partial tone with another of the pitch shifted partial tones, a third partial tone, if the third partial tone has been shifted to the same pitch as the first partial tone.

FIG. 1a illustrates a time stream S of a piano roll by Brahms in an audio file 10. Herein, MIDI is used as an example audio file format. In the figure, the x-axis is time and the y-axis is pitch, and a plurality of tones T, here eleven tones T1-T11, are shown in accordance with their respective time durations and pitch.

An edit operation is illustrated, in which two beats of a measure, between a first time point t_{A} and a second time point t_{B} (illustrated by dashed lines in the figure) are cut out and inserted in a later measure of the stream, in a cut at a third time point t_{C}. To perform the edit operation, three cuts A, B and C are made at the first, second and third time points t_{A}, t_{B} and t_{C}, respectively. The first cut A produces a first stream S1 (to the left of the cut A in the figure) and a second stream S2 (to the right of the cut A in the figure). The second cut B produces a third stream S3 (to the left of the second cut B, and to the left of the first stream S1, in the figure). The third cut C produces a fourth stream S4 (to the right of the third cut C, and to the right of the second stream S2, in the figure).

The three cuts A, B and C cut some of the tones T into different parts of said tones. For instance, the first tone T1 is by the first cut A cut into a first part T1a and a second part T1b. The first part T1a is also cut by the second cut B into two parts. This is in the figure illustrated by the third part T1c. However, this third part T1c may also be regarded as a first part of the tone T1 when cut by the second cut B. Further, the seventh tone T7 is by the third cut C cut into a first part T7a and a second part T7b. Other tones are similarly cut into parts.

FIG. 1b shows the piano roll produced when the edit operation has been performed in a straightforward way, i.e., when considering the tones T as mere time intervals. Thus, the time section, stream S1, between the first and second time points to and t_{B} in FIG. 1a has been inserted between the second stream S2 and the fourth stream S4. Tones that are extending across any of the cuts A, B and/or C are segmented into first and second (and possibly further) parts Ta and Tb, leading to several musical inconsistencies (herein also called artefacts). For instance, long tones, such as the high tones T1 and T7, are split into several contiguous short notes formed by the parts T1c and T1b, and T7a, T1a and T7b, respectively. This alters the listening experience, as several attacks are heard, instead of a single one. Additionally, the tone velocities (a MIDI equivalent of loudness) are possibly changing at each new attack, which is quite unmusical. Another issue is that splitting notes with no consideration of the musical context may lead to creating excessively short note fragments, also called residuals. Fragments are disturbing, especially if their velocity is high, and are perceived as clicks in the audio signals. Also, a side effect of the edit operation may be that some notes are quantized (resulting in a sudden change of pitch when jumping from one tone to another). As a result, slight temporal deviations present in the original MIDI stream are lost in the process. Such temporal deviations may be important parts of the performance, as they convey the groove, or feeling of the piece, as interpreted by the musician.

In FIG. 1b, tone splits are marked by dash-dot-dot-dash lines, where long tones are split, creating superfluous attacks, fragments (too short tones) are marked by dotted lines, and undesirable quantization, where small temporal deviations in respect of the metrical structure are lost, are marked by dash-dot-dash lines. Additionally, surprising and undesired changes in velocity (loudness) may occur at the seams 11 (schematically indicated by dashed lines extending outside of the illustrated stream S).

FIG. 1c shows how the edited piano roll of FIG. 1b may be after processing to remove the artefacts, as facilitated by the information stored in the memory spaces allocated to the different parts of the tones cut by any of the cuts A, B and C. Fragments, splits and quantization problems have been removed or reduced to produce the new tones N1-N14. For instance, all fragments marked in FIG. 1b have been deleted (e.g. duration adjusted to zero), all splits marked in FIG. 1b have been removed by fusing the tone across the seam 11, and quantization problems have been removed or reduced by extending some of the new tones across the seam, e.g. tones N9, N10 and N14, in order to recreate the tones to be similar as before the editing operation, or to their original states in accordance with the information stored in the memory spaces allocated to the tone parts, in effect reconnecting the deleted fragments to the tones.

Cut, copy, and paste operations may be performed using two basic primitives: split (i.e. cutting, as the term is used herein) and concatenate. The split primitive is used to separate an audio stream S (or MIDI file) at a specified temporal position, e.g. time point t_{A}, yielding two streams, e.g. a first stream S1 and a second stream S2, wherein the first stream S1 contains the music played before the cut A and the second stream S2 contains the music played after the cut A. The concatenate operation takes two audio streams S1 and S2 as input and returns a single stream S by appending the second stream to the first one (see e.g. FIG. 3c). To cut out a section S1 of an audio stream S, as in FIG. 1a, between a first time point t_{A} and a second time point t_{B}, the following primitive operations are performed:
1. Cut time stream S at time point t_{A}, which returns first and second streams S1 and S2.
2. Cut the first stream S1 at time point t_{B}, which returns the third stream S3 and an adjusted (shortened) first stream S1, S1 corresponding to the section between time points t_{A} and t_{B}.
3. Store the first stream S1 to a digital clipboard.
4. Return the concatenation of the third stream S3 and the second stream S2.
Similarly, to insert a stream, e.g. stored stream S1 (as above), in a stream S at time point t_{C}, one may:
1. Cut the stream S at the third time point t_{C}, producing two streams, the part of S prior to t_{C} in time, and the fourth stream S4 which is the part of S after t_{C}.
2. Return the concatenation of S2, S1, and S4, in that order.

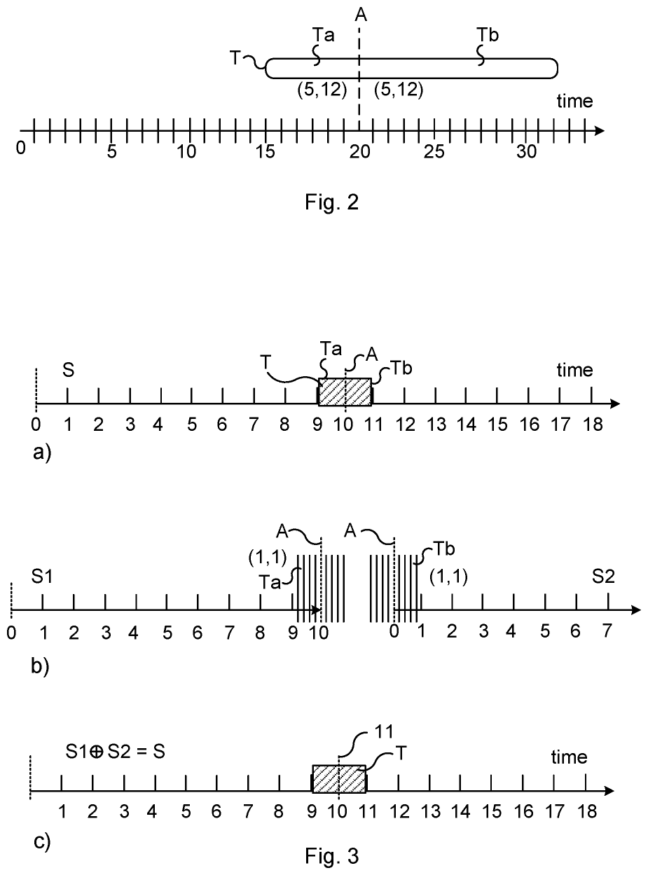

FIG. 2 illustrates cutting an original tone T with a cut A at a time t_{A} of 20, producing a first part Ta of the tone T, before the cut A, and a second part Tb of the tone T, after the cut A. Information about the original state of the tone T is stored in respective memory spaces allocated to each of the first and second parts Ta and Tb of the tone T. In the example of FIG. 2, information relating to the duration (i.e. length) of the original tone T is stored in the allocated memory spaces. However, other information about the original state of the tone T may additionally or alternatively be stored in the memory spaces, e.g. information relating to pitch and/or velocity/loudness of the original tone T. It should again be noted that the stored information is about the original state of the tone T, not about any intermediate state(s) resulting from a sequence of editing operations. Thus, regardless of how many parts the Tone is cut into, or how many times these parts are adjusted (including if the duration is adjusted to zero), each of the parts will always have information about the original state of the tone T, e.g. enabling the original tone to be recreated regardless of the type and number of editing operations have been performed.

The information about the original duration of the tone T may include a single number of seconds or other time unit, seventeen for the original tone T in FIG. 2 which extends between time 15 and time 32. Alternatively, as illustrated by “(5, 12)” in FIG. 2, the stored information about the original duration may specify that the original tone extended a specified number time units (here five) before the cut A and a specified number of time units (here twelve) after the cut A. This may give more information which may be useful for later recreating the original tone than a single number. Alternatively, negative numbers may be used for indicating that a partial tone Tb used to start earlier in its original state T. For instance, if stream S has a tone T which starts at time t=100 and ends at time t=300, and this stream S is cut to produce a first stream S1 and a second stream S2. Then, stream S1 contains a first part Ta of the tone that starts at t=100 and ends at t=200, but has a memory space allocated to said first part Ta which contains information about that the original tone T started at t=100 and ended at t=300. However, stream S2 contains a second part Tb of the tone that starts at t=0 and ends at t=100, but has a memory space allocated to said second part Tb which contains information about that the original tone T started at t=−100 and ended at t=100.

As discussed herein, the information stored in the respective memory spaces may be used for determining how to handle the tones T extending across a cut A when concatenating either of the thus formed first and second streams S1 and S2 with another stream (of the same time stream S or of another time stream or audio file 10). In accordance with embodiments of the present invention, a part of a tone T in a first stream S1 can, after concatenating with another stream, be adjusted based on the information about the original state of the tone stored in the memory space of the part of the tone.

Examples of such adjusting includes:

Removing the tone part Ta or Tb, e.g. if the tone part has a duration which is below a predetermined threshold or has a duration which is less than a predetermined percentage of the original tone T (cf. the fragments marked in FIG. 1b).

Extending a tone part Ta or Tb over the concatenation seam 11. For instance, the information stored in the memory space of the tone part may indicate that it is suitable that the tone part is extended across the seam, i.e. to assume the same duration as the original tone.

Merging a tone part Ta of the first stream S1 with another tone part Ta or Tb of the further stream, across the seam 11, thus avoiding the splits and quantized situations discussed herein (cf. tones N1, N2, N3, N4, N5, N7 and N8 of FIGS. 1b and 1c).

Regarding removal of fragments, i.e. adjusting the duration of the tone part to zero, in some embodiments, two different duration thresholds may be used, e.g. an upper threshold and a lower threshold. In that case, if the duration of a tone part Ta or Tb which is created after making a cut A is below the lower threshold, the tone part is regarded as a fragment and its duration is adjusted to zero to remove it from the audio stream as played (though the memory space remains for the tone part having a zero duration), regardless of its percentage of the original tone duration. On the other hand, if the duration of the tone part Ta or Tb which is created after making a cut A is above the upper threshold, the part is kept in the audio stream, regardless of its percentage of the original tone duration. However, if the duration of the tone part Ta or Tb which is created after making a cut A is between the upper and lower duration thresholds, whether it is kept or removed (duration adjusted to zero) may depend on its percentage of the original tone duration, e.g. whether it is above or below a percentage threshold. This may be used e.g. to avoid removal of long tone parts just because they are below a percentage threshold.

FIG. 3 illustrates how the allocated memory spaces enable to avoid fragments while not losing information about the original state of partial tones.

In FIG. 3a, a cut A (at time t_{A}) is made in the time stream S, dividing tone T into a first part Ta and a second part Tb of the tone T. Since the tone T extends across the cut A (cf. FIG. 2), information about the original state of the tone T is stored both in the memory space allocated to the first part Ta and in the memory space allocated to the second part Tb.

In FIG. 3b, the cut A has resulted in the time stream S having been divided into a first stream S1 (before the cut A in time), and a second stream S2 (after the cut A in time). It is determined that the first part Ta of the tone T in the first stream S1 and the second part Tb of the tone T in the second stream S1 are each so short as to be regarded as a fragment and they are both removed from their respective streams S1 and S2 as played. This may be done by adjusting the duration of each of the parts Ta and Tb to zero. However, the partial tones Ta and Tb still remain in the audio file 10 and in their respective streams S1 and S2, but with a duration of zero so as not to be played, and the time spaces remain allocated to the partial tones. That the partial tone Ta or Tb is so short that it is regarded as a fragment may be decided based on it being below a duration threshold or based on it being less than a predetermined percentage of the original tone T. However, thanks to the information about the original tone T being stored in both of the respective time spaces allocated to the partial tones Ta and Tb, the tone T as it was originally, i.e. before divided by the cut A, and possibly before any other editing operation preceding the cutting with cut A which affected the tone T, is remembered, e.g. as “(1, 1)” in the figure, in both the memory space allocated to the first part Ta and the memory space allocated to the second part Tb, as illustrated by the hatched boxes in the figure.

In FIG. 3c, the first and second streams S1 and S2 are re-joined by concatenating the ends of the streams produced by the cut A. By virtue of the information stored in the respective memory spaces, the previous existence of the original tone T is known and recreation of the tone is enabled. Thus, the original time stream S can be recreated, which would not have been possible without the use of the memory spaces and the information stored therein.

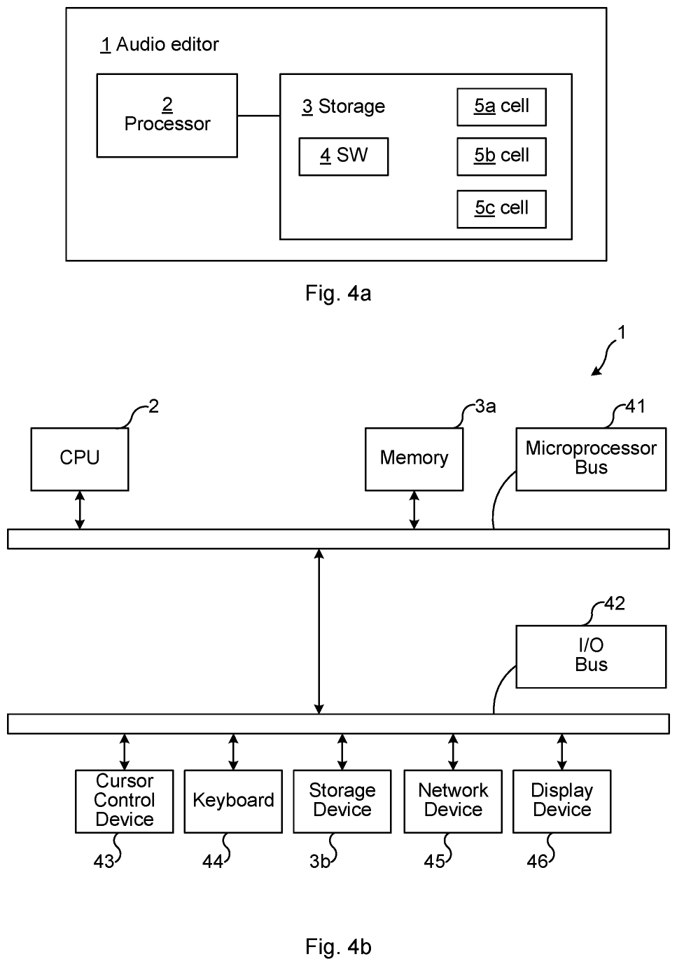

FIG. 4a illustrates an embodiment of an audio editor 1, e.g. implemented in a dedicated or general purpose computer by means of software (SW). The audio editor comprises processing circuitry 2 e.g. a central processing unit (CPU). The processing circuitry 2 may comprise one or a plurality of processing units in the form of microprocessor(s), such as Digital Signal Processor (DSP). However, other suitable devices with computing capabilities could be comprised in the processing circuitry 2, e.g. an application specific integrated circuit (ASIC), a field programmable gate array (FPGA) or a complex programmable logic device (CPLD). The processing circuitry 2 is configured to run one or several computer program(s) or software (SW) 4 stored in a data storage 3 of one or several storage unit(s) e.g. a memory. The storage unit is regarded as a computer readable means and may e.g. be in the form of a Random Access Memory (RAM), a Flash memory or other solid state memory, or a hard disk, or be a combination thereof. The processing circuitry 2 may also be configured to store data in the storage 3, as needed. The storage 3 may also comprise the memory spaces 5 discussed herein. In the example of FIG. 4a, three memory spaces 5 are illustrated, a first memory spacer 5a, a second memory space 5b and a third memory space 5c.

FIG. 4b illustrates some more specific example embodiments of the audio editor 1. The audio editor can comprise a microprocessor bus 41 and an input-output (I/O) bus 42. The processing circuitry 2, here in the form of a CPU, is connected to the microprocessor bus 41 and communicates with the work memory 3a part of the data storage 3, e.g. comprising a RAM, via the microprocessor bus. To the I/O bus 42 are connected circuitry arranged to interact with the surroundings of the audio editor, e.g. with a user of the audio editor or with another computing device e.g. a server or external storage device. Thus, the I/O bus may connect e.g. a cursor control device 43, such as a mouse, joystick, touch pad or other touch-based control device; a keyboard 44; a long-term data storage part 3b of the data storage 3, e.g. comprising a hard disk drive (HDD) or solid-state drive (SDD); a network interface device 45, such as a wired or wireless communication interface e.g. for connecting with another computing device over the internet or locally; and/or a display device 46, such as comprising a display screen to be viewed by the user.

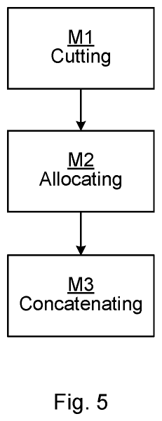

FIG. 5 illustrates an embodiment of the method of the present disclosure. The method is for editing an audio file. The audio file comprises information about a time stream S having a plurality of tones T extending over time in said stream. The method comprises cutting M1 the stream S at a first time point to of the stream, producing a first cut A cutting the stream S into a first stream S1 and a second stream S2, whereby each tone T, of the plurality of tones, which extends across the first cut A, is cut into a first part Ta which is in the first stream S1 and a second part Tb which is in the second stream S2. The method also comprises, for each of the tones T extending across the first cut A, allocating M2 a respective memory space 5 to each of the first part Ta of the tone T and the second part Tb of the tone T, each of the memory spaces 5 storing information about an original state of the tone T, typically comprising or consisting of the original duration of the tone. The method also comprises concatenating M3 the first stream S1 with a further stream S2, S3 or S4, comprising adjusting, typically the duration of, the first part Ta of one of the tones T which extended over the first cut A based on the information stored in the memory space 5 allocated to said first part of the tone.

In some embodiments of the present invention, the audio file is in accordance with a MIDI file format, which is a convenient format for editing audio files.

Additionally or alternatively, in some embodiments of the present invention, the information about the original state of the tone T comprises or consists of information about any or all of duration, pitch and velocity of the original tone, preferably only about the duration.

Additionally or alternatively, in some embodiments of the present invention, the adjusting of the first part Ta of the tone T includes or consists of adjusting any or all of duration, pitch and velocity, preferably only the duration.

Additionally or alternatively, in some embodiments of the present invention, the further stream is from the time stream S, i.e. from the same stream S as the first time stream S1. In some embodiments, the further stream may be the second time stream S2. In some other embodiments, the further stream S3 or S4 has been produced by cutting the first stream S1 or the second stream S2 at a further time point t_{B} or t_{C}.

The present disclosure has mainly been described above with reference to a few embodiments. However, as is readily appreciated by a person skilled in the art, other embodiments than the ones disclosed above are equally possible within the scope of the present disclosure, as defined by the appended claims.

1. A method of editing an audio file (10), the audio file comprising information about a time stream (S) having a plurality of tones (T) extending over time in said stream, the method comprising:
cutting (M1) the stream (S) at a first time point (t_{A}) of the stream, producing a first cut (A) cutting the stream into a first stream (S1) and a second stream (S2), whereby each tone (T), of the plurality of tones, which extends across the first cut, is cut into a first part (Ta) which is in the first stream and a second part (Tb) which is in the second stream;
for each of the tones (T) extending across the first cut (A), allocating (M2) a respective memory space (5) to each of the first part (Ta) of the tone and the second part (Tb) of the tone, each of the memory spaces storing information about an original state of the tone; and
concatenating (M3) the first stream (S1) with a further stream (S2/S3/S4), comprising adjusting the first part (Ta) of one of the tones (T) which extended over the first cut (A) based on the information stored in the memory space (5) allocated to said first part of the tone.

2. The method of claim 1, wherein the audio file (10) is in accordance with a Musical Instrument Digital Interface, MIDI, file format.

3. The method of claim 1, wherein the information about the original state of the tone (T) comprises information about any or all of duration, pitch and velocity of the original tone, preferably about the duration.

4. The method of claim 1, wherein the adjusting of the first part (Ta) of the tone (T) includes adjusting any or all of duration, pitch and velocity, preferably the duration.

5. The method of claim 1, wherein the further stream (S2/S3/S4) is from the time stream (S).

6. The method of claim 5, wherein the further stream is the second stream (S2).

7. The method of claim 5, wherein the further stream (S3/S4) is produced by cutting the first stream (S1) or the second stream (S2) at a further time point (t_{B}/t_{C}).

8. A non-transitory computer program product (3) for editing an audio file (10), the audio file comprising information about a time stream (S) having a plurality of tones (T) extending over time in said stream, the non-transitory computer program product (3) comprising computer-executable components (4) for causing an audio editor (1) to:
cut the stream (S) at a first time point (t_{A}) of the stream, producing a first cut (A) cutting the stream into a first stream (S1) and a second stream (S2), whereby each tone (T), of the plurality of tones, which extends across the first cut, is cut into a first part (Ta) which is in the first stream and a second part (Tb) which is in the second stream;
for each of the tones (T) extending across the first cut (A), allocate a respective memory space (5) to each of the first part (Ta) of the tone and the second part (Tb) of the tone, each of the memory spaces storing information about an original state of the tone; and
concatenate the first stream (S1) with a further stream (S2/S3/S4), comprising adjusting the first part (Ta) of one of the tones (T) which extended over the first cut (A) based on the information stored in the memory space (5) allocated to said first part of the tone.

9. An audio editor (1) configured for editing an audio file (10), the audio file comprising information about a time stream (S) having a plurality of tones (T) extending over time in said stream, the audio editor comprising:
processing circuitry (2); and
data storage (3) storing instructions (4) executable by said processing circuitry whereby said audio editor is operative to:
cut the stream (S) at a first time point (t_{A}) of the stream, producing a first cut (A) cutting the stream into a first stream (S1) and a second stream (S2), whereby each tone (T), of the plurality of tones, which extends across the first cut, is cut into a first part (Ta) which is in the first stream and a second part (Tb) which is in the second stream;
for each of the tones (T) extending across the first cut (A), allocate a respective memory space (5) to each of the first part (Ta) of the tone and the second part (Tb) of the tone, each of the memory spaces storing information about an original state of the tone; and
concatenate the first stream (S1) with a further stream (S2/S3/S4), comprising adjusting the first part (Ta) of one of the tones (T) which extended over the first cut (A) based on the information stored in the memory space (5) allocated to said first part of the tone.
